(19) United States
(12) Patent Application Publication
(10) Pub. No.: US 2026/0070064 A1
(43) Pub. Date: Mar. 12, 2026

(54) Grinder Systems And Methods For Grinding Samples

(71) Applicant: MONSANTO TECHNOLOGY LLC, St. Louis, MO (US)

(72) Inventor: Christopher Ramsey EVANS, Ankeny, IA (US)

(21) Appl. No.: 19/102,292

(22) PCT Filed: Aug. 10, 2023
(86) PCT No.: PCT/US2023/030023

§ 371 Date: Feb. 7, 2025

Related U.S. Application Data
(60) Provisional application No. 63/397,265, filed on Aug. 11, 2022.

(51) Int. Cl. B02C 17/14; B02C 17/10; B02C 17/24; G01N 1/28

(52) U.S. Cl. CPC B02C 17/14; B02C 17/10; B02C 17/24; G01N 1/286; G01N 2001/2866

(57) ABSTRACT

Grinder systems and methods for grinding a sample in a sample block are provided. One example grinder system includes a cylinder and a piston positioned in a bore of the cylinder and configured to move along a longitudinal axis of the cylinder. A first end portion of the cylinder is configured to couple to a sample block. A first air port is disposed adjacent the first end portion of the cylinder, and a second air port is disposed adjacent a second, opposite end portion of the cylinder. A controller is configured to control air pressure in the first and second end portions of the cylinder, via the first and second air ports, to thereby linearly move the cylinder in a first direction and the piston in a second, opposite direction to agitate a grinding device in the sample block to grind a corresponding sample therein.

### CROSS-REFERENCE TO RELATED APPLICATION

This application claims the benefit of, and priority to, U.S. Provisional Patent Application No. 63/397,265 filed Aug. 11, 2022. The entire disclosure of the above application is incorporated herein by reference.

### FIELD

The present disclosure generally relates to grinder systems (e.g., pneumatic grinder systems, other grinder systems, etc.), and to methods for grinding samples.

### BACKGROUND

This section provides background information related to the present disclosure which is not necessarily prior art.

Samples of biological materials are often analyzed to determine various traits or characteristics of the biological materials. Such biological materials can include, for example, plants, animals, and/or materials derived therefrom. Materials derived from plants may include, for example, plant parts and plant tissue such as whole seeds, tissue samples from seeds, leaf tissues, root tissues, stem tissues, flower tissues, fruit tissues, etc. Animals may include, for example, insects, nematodes, and arachnids, and materials derived from animals may include tissues derived from insects, nematodes, and arachnids. To analyze such samples, the samples may need to be ground into very small particulates. Various tests can then be performed on the ground samples to determine various traits or characteristics. Grinders are often employed to grind the samples. The grinders often rely on various motors, transmissions, seals, etc. to agitate and grind the samples.

### SUMMARY

This section provides a general summary of the disclosure and is not a comprehensive disclosure of its full scope or all of its features.

Example embodiments of the present disclosure generally relate to grinder systems configured to oscillate a cylinder and a piston in opposing directions through controlled air pressure, thereby agitating a sample and a grinding device in a sample block to grind the sample.

In one example embodiment, such a grinder system generally includes: a cylinder including a first end portion and a second end portion opposing the first end portion, the cylinder defining a bore extending along a longitudinal axis of the cylinder, the first end portion of the cylinder configured to couple to a sample block configured to hold at least one sample and at least one grinding device, the cylinder configured to linearly move in at least a first direction; a first air port adjacent to the first end portion of the cylinder; a second air port adjacent to the second end portion of the cylinder; a piston positioned in the bore of the cylinder and configured to move along the longitudinal axis of the cylinder; and a controller configured to control air pressure in the first end portion and the second end portion of the cylinder via the first air port and the second air port, to thereby linearly move the cylinder in at least the first direction and the piston in at least a second direction opposite the first direction to agitate at least one grinding device in the sample block to grind the at least one sample in the sample block.

In another example embodiment, a grinder system of the present disclosure generally includes a housing assembly including a first member and a second member, the first member configured to couple to a sample block and including a first air port and a first sensor, and the second member including a second air port and a second sensor; a cylinder coupled between the first member and the second member of the housing assembly, the cylinder defining a bore extending along a longitudinal axis of the cylinder; at least one rail assembly including a rod extending parallel to the cylinder and a spring positioned about the rod, the housing assembly and the cylinder configured to linearly move along the rod in a first direction and in a second direction opposite the first direction; a piston positioned in the bore of the cylinder and configured to move along the longitudinal axis of the cylinder; and a controller in communication with the first sensor and the second sensor, the controller configured to receive a feedback signal from the first sensor or the second sensor indicative of a position of the piston in the bore of the cylinder, and in response to the feedback signal, control air pressure in the cylinder via the first air port and the second air port, to thereby linearly move the piston in a direction opposite a direction of movement of the housing assembly and the cylinder, and agitate at least one grinding device in the sample block to grind at least one sample.

In still another example embodiment, a grinder system of the present disclosure generally includes a first support configured to hold a sample block and move the sample block, the sample block configured to hold at least one sample and at least one grinding device for grinding the at least one sample as the first support moves the sample block; a second support configured to cover the sample block; and a clamping device configured to releasably secure the second support to the first support to thereby secure the sample block between the first support and the second support, wherein the clamping device includes a clutch configured to automatically tighten the second support to the first support as the first support moves the sample block.

Example embodiments of the present disclosure also generally relate to methods of grinding samples in sample blocks coupled to cylinders of grinding systems. One example method generally includes controlling air pressure in a cylinder to linearly move a piston in a bore of the cylinder in a first direction and linearly move the cylinder in a second direction opposite the first direction, thereby agitating (by moving the sample block) at least one grinding device in the sample block to grind the at least one sample.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is a block diagram of an example embodiment of a grinder system of the present disclosure configured to grind samples (e.g., tissue samples, other samples (organic or inorganic), etc.) by linearly moving a cylinder and a piston in opposing directions through controlled air pressure;

FIG. 2A is a front view of another example embodiment of a grinder system of the present disclosure configured to grind samples by linearly moving a cylinder and a piston in opposing directions through controlled air pressure;

FIG. 2B is a cross sectional side view of the grinder system of FIG. 2A;

FIG. 2C is a side view of the grinder system of FIG. 2A;

FIG. 2D is a cross sectional front view of the grinder system of FIG. 2A;

FIG. 2E is an isometric view of the grinder system of FIG. 2A;

FIG. 2F is an exploded view of the grinder system of FIG. 2A;

FIG. 3 is an isometric view of another example embodiment of a grinder system of the present disclosure configured to linearly move a cylinder and a piston in opposing directions through controlled air pressure, for example, to grind samples (e.g., tissue samples, other samples (organic or inorganic), etc.);

FIGS. 4A-E illustrate example operations of the grinder system of FIGS. 2A-F to grind samples, as part of a method of controlling air pressure to oscillate the cylinder and the piston of the grinder system;

FIG. 5A is a front view of a case including the grinder system of FIGS. 2A-F;

FIG. 5B is a side view of the case of FIG. 5A;

FIG. 5C is an isometric view of the case of FIG. 5A; and

FIG. 6 is a front isometric view of a sample block employable in the grinder systems of FIGS. 1-5C.

Corresponding reference numerals indicate corresponding parts throughout the several views of the drawings.

### DETAILED DESCRIPTION

Grinders are often used to grind samples of biological material and other material such as dirt, rocks, and pharmaceutical materials. For example, grinders can be used to grind plants, plant parts, and plant tissues such as, for example, whole seeds, seed parts, seed tissue, leaves, leaf tissue, stems, stem tissue, roots, root tissue, flowers, flower tissue, fruit, fruit tissue, etc. Grinders can also be used to grind animals and materials derived from animals such as, for example, whole insects, whole nematodes, whole arachnids, and parts and/or tissue derived from any thereof. In some examples, the insects, nematodes, or arachnids may be considered plant pests. Following grinding, the materials can be analyzed to determine various traits and/or characteristics of the samples. For example, nucleic acids and/or proteins can be extracted from the samples and analyzed.

The grinders typically rely on various motors, transmissions, seals, etc. to agitate and grind the samples. Such grinders often have a limited lifespan in production and/or require frequent replacement and/or repair of components.

Uniquely, the grinder systems and methods herein leverage air pressure to move components to disrupt and grind samples. For example, the grinder systems and methods herein rely on controlled air pressure to move a cylinder and a piston in opposite linear directions. The linear movements in opposing directions (e.g., oscillation or oscillating movement, etc.) causes a sample block holding one or more samples and one or more grinding devices (e.g., BBs, ball bearings, sand or other coarse powder/material, metal cylinders and/or other shaped small objects, etc.) to move, thereby agitating the samples and grinding (via the grinding devices) the samples. Because the agitation results from the linear movements of the cylinder and the piston based on the controlled air pressure, motors and transmissions may not be required to agitate and grind the samples. Additionally, seals may not be required between components (e.g., the piston and the cylinder, etc.) moving relative to one another (as described more herein). As such, the grinder systems and methods provided for herein may experience a longer lifespan and require less replacement/repair of components as compared to conventional grinders.

Example embodiments will now be described more fully with reference to the accompanying drawings. The description and specific examples included herein are intended for purposes of illustration only and are not intended to limit the scope of the present disclosure.

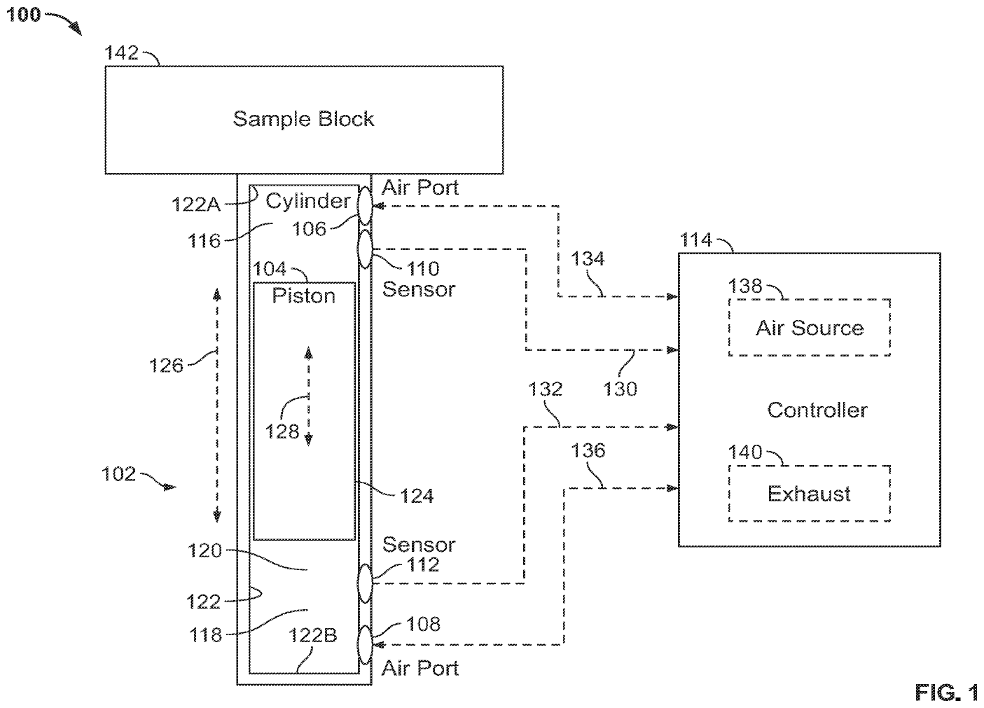

FIG. 1 illustrates an example embodiment of a grinder system 100 including one or more aspects of the present disclosure. As will be described, the grinder system 100 is configured (e.g., is constructed and operable, etc.) to linearly move (e.g., oscillate, etc.) a cylinder and a piston in opposing directions through controlled air pressure (such that the grinder system 100 of the current embodiment may be viewed as a pneumatic grinder system, etc.), thereby agitating a sample and a grinding device in a sample block of the system and grinding the sample. Once the sample is ground to a desired level, portions of the sample (e.g., the ground portions of the sample, DNA extracted from the ground sample where the sample is a tissue sample, etc.) may be analyzed to determine various traits and/or characteristics of the sample through conventional measures. That said, it should be appreciated that the grinder system 100 may be used to grind various different materials (including samples thereof). For instance, the grinder system 100 may be used grind biological material and samples thereof, such as plants, plant parts, and plant tissues (e.g., whole seeds, seed parts, seed tissue, leaves, leaf tissue, stems, stem tissue, roots, root tissue, flowers, flower tissue, fruit, fruit tissue, etc.). The grinder system 100 may also be used to grind animals and materials derived from animals (e.g., whole insects, whole nematodes, whole arachnids, parts and/or tissue derived from any thereof, parts and/or tissue derived from other animals, etc.). The grinder system 100 may further be used to grind other material such as dirt, rocks, and pharmaceutical materials. In general, the grinder system 100 may be used to grind any desired organic or inorganic material.

As shown in FIG. 1, the illustrated grinder system 100 generally includes a cylinder 102, a piston 104 positioned in the cylinder 102, air ports 106, 108, sensors 110, 112, and a controller 114. The cylinder 102 and the piston 104 are both configured to linearly move, as shown by dashed arrows 126, 128 (e.g., generally longitudinally, etc.), based on controlled air pressure (provided to the air ports 106, 108) as configured by the controller 114. Although the system 100 of FIG. 1 is illustrated and described as including the cylinder 102 and the corresponding piston 104, it should be appreciated that any suitable shaped objects, parts, features, etc. may be employed, provided both objects, parts, features, etc. are movable relative to teach other and that one of the objects, parts, features, etc. is movable within (or otherwise relative to) the other object, part, feature, etc. For example, instead of employing the cylinder 102 and the corresponding piston 104, the system 100 may include a hollow rectangular object and a corresponding rectangular object positioned within the hollow rectangular object.

In the illustrated example of FIG. 1, the cylinder 102 includes opposing end portions 116, 118 and a bore 120 (e.g., an opening, an open interior region, etc.) extending along a longitudinal axis of the cylinder 102 (for example, generally between the end portions 116, 118, generally from end portion 116 to end portion 118, etc.). More specifically, the cylinder 102 includes an inner surface 122 extending between opposing ends (e.g., between opposing end portions 116, 118, etc.) of the cylinder 102, where the inner surface 122 then generally defines the bore 120. In the example of FIG. 1, the cylinder 102 is coupled (e.g., directly or indirectly, etc.) to a sample block 142. For example, in FIG. 1, the end portion 116 of the cylinder 102 is configured to couple to the sample block 142 (e.g., via mechanical connectors or fasteners, via welds, via intermediate connections, etc.).

The piston 104 is positioned in the bore 120 of the cylinder 102 and is configured to move within the bore 120. The piston 104 may be a solid piece of material, a hollow piece of material having a solid perimeter, or other construction, etc. In the illustrated example of FIG. 1, the piston 104 is shorter in length than the cylinder 102, thereby allowing the movement of the piston 104 within the cylinder 102 (e.g., longitudinally within the cylinder 102, etc.). As nonlimiting examples, the length of the piston 104 (e.g., as determined along a longitudinal axis of the piston 104 extending generally in a direction of the arrow 128, etc.) may be, for example, about 5 inches, about 6 inches, about 7 inches, more or less than about 5 inches, more than about 6 inches, more or less than about 7 inches, and/or any other suitable distance, etc. In addition (or alternatively), in such examples, the length of the cylinder 102 (e.g., as determined along the longitudinal axis of the cylinder 102 between the end portions 116, 118 (e.g., extending generally in a direction of the arrow 126, etc.); etc.) may be any suitable distance greater than the length of the piston, such as, for example, about 6 inches, about 7 inches, about 8 inches, more or less than about 6 inches, more or less than about 7 inches, more or less than about 8 inches, and/or any other distance, etc.

With continued reference to FIG. 1, the cylinder 102 and the piston 104 create an airtight or substantially airtight seal therebetween (e.g., the seal is sufficiently restrictive such that a force from the air pressure behind the piston 104 is enough to drive the piston 104, etc.). For example, in FIG. 1, the piston 104 includes an outer surface 124 defining an outer perimeter (broadly, an outer portion) of the piston 104. In this example, then, the cylinder 102 and the piston 104 are configured to create an airtight seal between the outer surface 124 of the piston and the inner surface 122 of the cylinder 102. In doing so, a distance between opposing sides of the inner surface 122 (e.g., a diameter, etc.) of the cylinder 102 and a distance between opposing sides of the outer surface 124 (e.g., a diameter, etc.) of the piston 104 may be selected to create an airtight seal between the inner surface 122 of the cylinder 102 and the outer surface 124 of the piston 104. In some examples, a layer of oil (e.g., pneumatic oil, etc.) may be employed between the piston 104 and the cylinder 102 to help create the airtight seal. By creating the airtight seal between the cylinder 102 and the piston 104, pockets (e.g., air pockets, etc.) may be formed in the end portions 116, 118 of the cylinder 102 (e.g., generally above and below the piston 104 as viewed in FIG. 1, etc.). What's more, in some example embodiments such airtight seal between the cylinder 102 and the piston 104 may remove need for additional gaskets or other mechanical seals therebetween (e.g., such that the airtight seal between the cylinder 102 and the piston is formed without use of a separate gasket or mechanical seal, etc.).

In the illustrated example of FIG. 1, the air ports 106, 108 are adjacent to the opposing end portions 116, 118 of the cylinder 102, respectively. In some embodiments, the air ports 106, 108 may be openings in the cylinder 102 configured to receive and/or exhaust air. As such, in the example of FIG. 1, the cylinder 102 may define at least a portion of the air ports 106, 108 as shown in FIG. 1. In other examples, the air ports 106, 108 may include another suitable type of port configured to receive and/or exhaust air (and still be in communication with the end portions of the 116, 118 of the cylinder 102, etc.).

As shown in the example of FIG. 1, the sensors 110, 112 are positioned adjacent to the air ports 106, 108 and the opposing end portions 116, 118 of the cylinder 102. More specifically, the sensor 110 is positioned generally below the air port 106 (as viewed in the example system 100 of FIG. 1), and the sensor 112 is positioned generally above the air port 108 (as viewed in the example system 100 of FIG. 1). With this arrangement, the air port 106 is positioned between a top side 122A of the cylinder 102 and the sensor 110 and the air port 108 is positioned between a bottom side 122B of the cylinder 102 and the sensor 112, as shown in FIG. 1. It should be appreciated that the sensors 110, 112 and/or the air ports 106, 108 may be arranged differently in other embodiments depending on, for example, the type of sensors employed, the type of air ports employed, etc.

The sensors 110, 112 are configured to sense a position of the piston 104 within the cylinder 102 and generate feedback signals 130, 132 for the controller 114 indicative of the position of the piston 104. For example, when the piston 104 moves downwards within the cylinder 102 (as viewed in FIG. 1), an upper portion of the piston 104 moves away from the sensor 110. In turn, the sensor 110 may be configured to sense an absence of the piston 104 relative to the sensor 110, movement of the piston 104 away from the sensor 110, etc., and generate the feedback signal 130 indicating the piston 104 is moving downward, is in a low position (e.g., a low threshold position, etc.), etc. Similarly, when the piston 104 moves upwards within the cylinder 102 (as viewed in FIG. 1), a lower portion of the piston 104 moves away from the sensor 112. In turn, the sensor 112 may be configured to sense an absence of the piston 104 relative to the sensor 112, movement of the piston 104 away from the sensor 112, etc., and generate the feedback signal 132 indicating the piston 104 is moving upward, is in a high position (e.g., a high threshold position, etc.). Alternatively, the sensors 110, 112 may be configured to sense the presence of the piston 104 (e.g., adjacent to the sensors 110, 112, etc.). For example, when a portion of the piston 104 is adjacent to the sensor 110 (or the sensor 112), the sensor 110 (or the sensor 112) may be configured to sense the position of the piston 104 and generate the feedback signal 130 (or the feedback signal 132) indicating the piston 104 is in a high position (or a lower position).

In the example of FIG. 1, the sensors 110, 112 may be any suitable type of sensors configured to detect the piston 104. For example, one or both sensors 110, 112 may include a magnetic switch sensor, an optical sensor, etc. In some examples, the sensors 110, 112 may be positioned in ports (broadly, openings) in the cylinder 102 as shown in FIG. 1. It should be appreciated, though, that the sensors 110, 112 may be arranged differently depending on, for example, the type of sensors employed, etc. For example, in some embodiments, the sensors 110, 112 may be positioned on an exterior side of the cylinder 102 and configured to sense a position of the piston 104 generally through the cylinder 102. Further, in some examples, the sensors 110, 112 may include air ports configured to control the system through “pneumatic logic”.

The controller 114 is configured to control air pressure in the cylinder 102 via the air ports 106, 108, to thereby linearly move the piston 104 and the cylinder 102 (relative to each other). For example, the controller 114 is coupled to the air ports 106, 108 via, for example, air hoses, tubes, etc. 134, 136. In such examples, the controller 114 is configured to control air pressure in the opposing end portions 116, 118 (e.g., in the pockets, chambers, voids, etc. associated therewith) of the cylinder 102. More specifically, the controller 114 is configured to supply air (e.g., compressed air, etc.) to one of the end portion 116, 118 via an air source 138 and remove air from the other end portion 116, 118 via an exhaust 140, thereby adjusting the air pressure in both end portions 116, 118. This may be accomplished by controlling, via the controller 114, one or more switching devices positioned between the air ports 106, 108 and the air source 138/the exhaust 140 to selectively connect each one of the air source 138 and the exhaust 140 to a desired one of the air ports 106, 108. As such, the controller 114 may be configured to increase the air pressure in (e.g., supply air to, etc.) one of the end portion 116, 118 and decrease air pressure in (e.g., exhaust air from) the other end portion 116, 118. Due to the changing air pressure, the cylinder 102 moves in one direction and the piston 104 moves (within the cylinder 102) in an opposing direction to create oscillation between the cylinder 102 and the piston 104 (e.g., oscillating movement, etc.). For example, if the air pressure in the end portion 116 is increased and the air pressure in the end portion 118 is decreased, the piston 104 moves linearly downwards (in the cylinder 102) and the cylinder 102 moves linearly upwards (e.g., based on a pushing and/or recoil effect of the air on both the piston 104 and the cylinder 102 within the end portion 116, etc.). However, if the air pressure in the end portion 116 is decreased and the air pressure in the end portion 118 is increased, the piston 104 moves linearly upwards and the cylinder 102 moves linearly downwards (e.g., based on a pushing and/or recoil effect of the air on both the piston 104 and the cylinder 102 within the end portion 118, etc.).

As explained above, the cylinder 102 is coupled to the sample block 142. As such, the sample block 142 moves along with the cylinder 102 when the cylinder 102 oscillates with the piston 104. In some examples, the oscillation may produce a sufficient acceleration force (e.g., G force, etc.) on the sample block 142 to agitate one or more samples and one or more grinding devices in the sample block 142. The rate of oscillation and the G force applied to the sample block 142 may be determined by, for example, the controllable air pressure (e.g., higher air pressure produces more oscillating cycles per minute, and vice versa) through the controller 114. As a result of the agitation, the sample(s) in the sample block 142 may be ground.

In some embodiments, the system 100 may be configured to create a self-oscillating interaction between the cylinder 102 and the piston 104. For example, the controller 114 is configured to automatically control the air pressure in the end portions 116, 118 of the cylinder 102 in response to the feedback signals 130, 132. More specifically, when the controller 114 receives one of the feedback signals 130, 132 indicating the piston 104 is moving downward, is in a low position, etc. (e.g., the sensor 110 senses an absence of the piston 104, the sensor 112 senses a presence of the piston 104, etc.), the controller 114 is configured to automatically increase the air pressure in the end portion 118 of the cylinder 102 via the air source 138 and to automatically decrease the air pressure in the end portion 116 of the cylinder 102 via the exhaust 140, to thereby cause the piston 104 to begin to move upwards and the cylinder 102 to move downwards. Once the controller 114 receives the other feedback signal 130, 132 indicating the piston 104 is moving upward, is in a high position, etc. (e.g., the sensor 112 senses an absence of the piston 104, the sensor 110 senses a presence of the piston 104, etc.), the controller 114 is configured to automatically decrease the air pressure in the end portion 118 of the cylinder 102 via the exhaust 140 and to automatically increase the air pressure in the end portion 116 of the cylinder 102 via the air source 138, to thereby cause the piston 104 to begin to move downwards and the cylinder 102 to move upwards. As a result, a self-oscillating interaction between the cylinder 102 and the piston 104 may be created based on the received feedback signals 130, 132.

The system 100 may also be configured to create a self-balancing interaction between the cylinder 102 and the piston 104 regardless of whether the mass of the cylinder 102 and the sample block 142 is the same or different than the piston 104. For example, a maximum stroke for the cylinder 102 and the piston 104 may be determined by a difference in length between the piston 104 and the cylinder 102 divided by two. If, for example, the length of the piston 104 is 6 inches and the length of the cylinder 102 is 8 inches, the difference in length is 2 inches. In such examples, the maximum stroke is 1 inch for the cylinder 102 (e.g., 2 inches/2, etc.) and 1 inch for the piston 104 (e.g., 2 inches/2, etc.). However, the actual stroke for the cylinder 102 and the piston 104 is controlled by, for example, sensed positions and the difference in mass between the cylinder 102/the sample block 142 and the piston 104. In some embodiments, the combined mass of the cylinder 102 and the sample block 142 may be the same or substantially similar to the mass of the piston 104. In some examples, each mass may be about 1 kg. In such embodiments, the piston 104 and the cylinder 102 may move the same linear distance (e.g., the same stroke, etc.) and experience the same acceleration but in opposite directions when air pressure is controlled between the piston 104 and the cylinder 102 as explained above. This creates a self-balancing interaction between the cylinder 102 and the piston 104. However, if the cylinder 102 and the sample block 142 have a higher (or lower) combined mass than the piston 104, the cylinder 102 and the sample block 142 may move a smaller (or larger) distance with a lower (or greater) maximum velocity as compared to the piston 104. Even with this difference in mass, though, acceleration forces still balance out as the cylinder 102/the sample block 142 and the piston 104 experience the same acceleration (in opposing directions) over a period of time. This is because the cylinder 102/the sample block 142 and the piston 104 are not directly linked together. As such, the system 100 is configured to create a self-balancing interaction between the cylinder 102 and the piston 104, regardless of whether the mass of the cylinder 102/the sample block 142 is the same or different than the piston 104.

In the illustrated embodiment of FIG. 1, the air source 138 (e.g., an air compressor, etc.) and the exhaust 140 (e.g., a vent, an air return, etc.) are shown as a part of the controller 114. It should be appreciated that the air source 138 and/or the exhaust 140 may be arranged differently in other embodiments. For example, the air source 138 may be an external component to the controller 114 while still supplying air to the pockets via the hoses 134, 136 as controlled by the controller 114, and/or the exhaust 140 may be an external component to the controller 114 while still removing air from the pockets via the hoses 134, 136 as controlled by the controller 114.

The controller 114 of FIG. 1 may be any suitable type of control device. For example, in some embodiments, the controller 114 may include a valve such as a shuttle valve, a solenoid valve, etc. In such embodiments, the valve is configured to actuate in response to the feedback signals 130, 132, to thereby control the air pressure in the cylinder 102 as explained above. In some examples, the valve may actuate (e.g., move, etc.) in a first manner to connect the air source 138 to one of the air ports 106, 108 (via its corresponding hose 134, 136) and connect the exhaust 140 to the other one of the air ports 106, 108 (via its corresponding hose 134, 136). The valve may then actuate (e.g., move, etc.) in a second manner to connect the air source 138 to the other one of the air ports 106, 108 (via its corresponding hose 134, 136) and connect the exhaust 140 to the other one of the air ports 106, 108 (via its corresponding hose 134, 136). This interaction of the valve, through the controller, may then help to cause the oscillating movement of the cylinder 102 and the piston 104.

In other embodiments, the controller 114 may include a processor and memory coupled to (and in communication with) the processor. For example, the processor may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein. The memory may be one or more devices that permit data, instructions, etc., to be stored therein and retrieved therefrom. For example, the memory may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. Furthermore, in various embodiments, computer-executable instructions may be stored in the memory for execution by the processor to cause the processor to perform one or more of the operations described herein in connection with the various different parts of the system 100, such that the memory is a physical, tangible, and non-transitory computer readable storage media.

In some examples, the controller 114 may include a control loop such as proportional-integral-derivative (PID) control loop to control operation of the cylinder 102 and the piston 104, via the air source 138 and exhaust 140. In such examples, the sensors 110, 112 may include one or more accelerometers configured to provide feedback for the control loop. In other examples, the system 100 may include one or more accelerometers together with the sensors 110, 112 to provide feedback for the control loop.

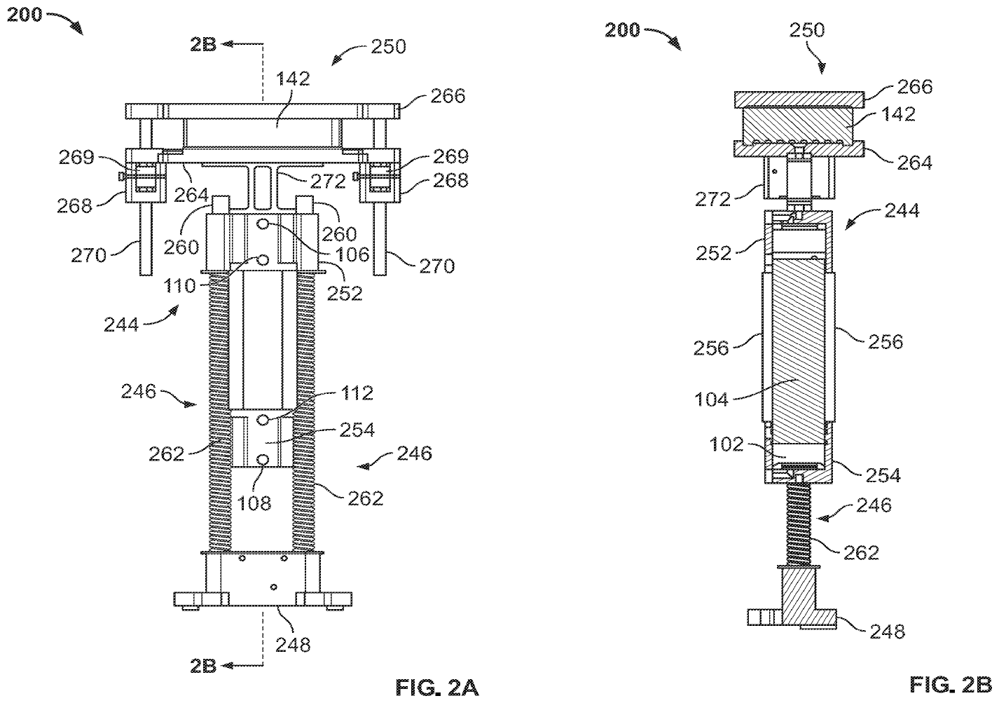

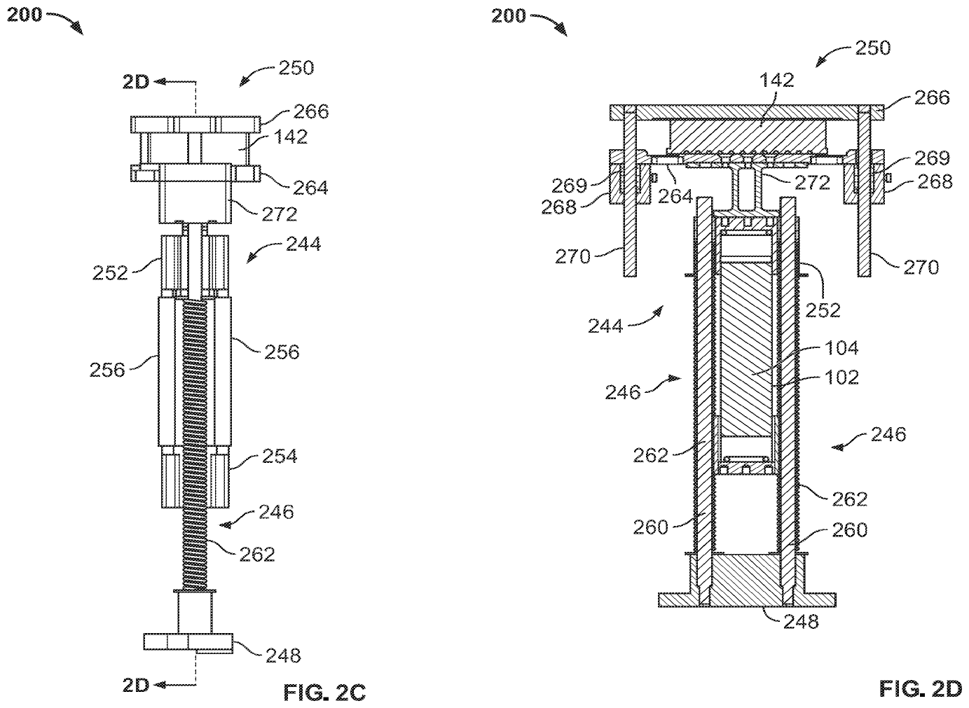

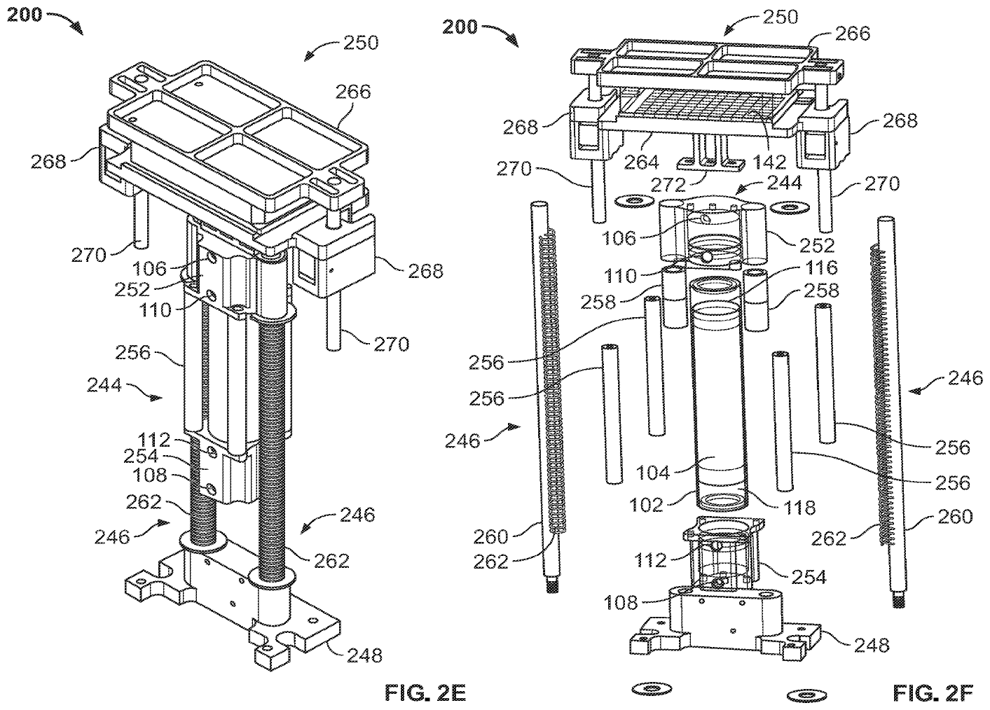

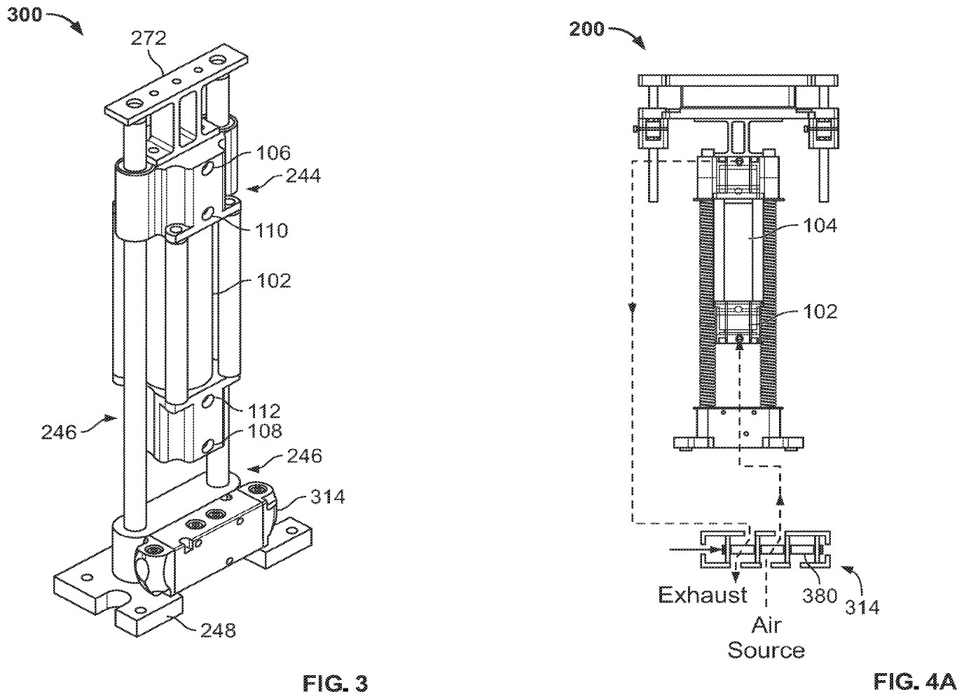

FIGS. 2A-2F illustrate another example embodiment of a grinder system 200 including one or more aspects of the present disclosure. FIGS. 2A-2F are sometimes collectively referred to herein as FIG. 2. Similar to the system 100 of FIG. 1, the grinder system 200 is configured (e.g., is constructed and operable, etc.) to linearly move (e.g., oscillate, etc.) a cylinder and a piston in opposing directions through controlled air pressure, thereby agitating one or more samples and one or more grinding devices in a sample block of the system 200 and grinding the samples. Once the samples are ground to a desired level, portions of the samples (e.g., DNA extracted from the sample, etc.) may be analyzed to determine various traits and/or characteristics of the samples through conventional measures.

The grinder system 200 of FIG. 2 is similar to the system 100 of FIG. 1 but includes additional structural components. For example, the system 200 includes the cylinder 102, the piston 104, the air ports 106, 108 and the sensors 110, 112 of FIG. 1. The illustrated system 200 additionally includes a housing assembly 244, rail assemblies 246, a support member 248, and a sample block assembly 250. Although not shown in FIG. 2, the air ports 106, 108 and the sensors 110, 112 are coupled to, in communication with, etc. a controller (e.g., controller 114, etc.) in a similar manner as in FIG. 1 (whereby description of the controller 114 in connection with the system 100 similarly applies to use of the controller 114 in the system 200).

As shown, the housing assembly 244 includes members 252, 254, rods 256 coupled between the members 252, 254, and bushings 258 coupled to the member 252. In the embodiment of FIG. 2, the member 252 (sometimes referred to herein as a top housing member 252) is coupled to the end portion 116 of the cylinder 102 and to the sample block assembly 250, and the member 254 (sometimes referred to herein as a lower member 254) is coupled to the end portion 118 of the cylinder 102. In some embodiments, one or more O-rings may be positioned between the members 252, 254 and the cylinder 102. The rods 256 (broadly, connecting members) extend along an exterior of the cylinder 102 and couple the members 252, 254 together. Although the housing assembly 244 is illustrated as including four rods 256, more or fewer rods may be employed in other embodiments. The bushings 258 are configured to guide the housing assembly 244 along the rail assemblies 246 when the housing assembly 244 moves as explained below.

In the illustrated embodiment of FIG. 2, the air ports 106, 108 and the sensors 110, 112 are shown as being located on the members 252, 254. Even though the air ports 106. 108 and the sensors 110, 112 are shown in this arrangement, the air ports 106, 108 and the sensors 110, 112 of FIG. 2 are configured to operate in a similar manner as the air ports 106, 108 and the sensors 110, 112 of FIG. 1. For example, the air ports 106, 108 of FIG. 2 are configured to receive air and/or exhaust air via one or more hoses, tubes, etc. (e.g., as controlled by the controller 114, etc.), to thereby adjust the air pressure in the end portions 116, 118 of the cylinder 102 as explained herein. Additionally, the sensors 110, 112 of FIG. 2 are configured to sense a position of the piston 104 (e.g., within the cylinder 102, etc.) and generate feedback signals for the controller (e.g., controller 114, etc.) indicative of the position of the piston 104 (e.g., within the cylinder 102, etc.) as explained herein.

In the illustrated embodiment, the rail assemblies 246 of FIG. 2 each include a rod 260 extending generally parallel to the cylinder 102 and a spring 262 positioned about the rod 260. The rods 260 of the rail assemblies 246 are coupled to and extend from the support member 248 towards the member 252 of the housing assembly 244. For example, each rod 260 includes one end coupled to the support member 248 and another opposing end adjacent to (e.g., coupled to, etc.) the member 252 of the housing assembly 244.

In the example of FIG. 2, the springs 262 are coupled between the member 252 of the housing assembly 244 and the support member 248. In some embodiments, one or more washers may be coupled between each spring 262 and the support member 248 and between each spring 262 and the member 252. In some examples, the springs 262 are not intended to move or otherwise return the housing assembly 244 when the housing assembly 244 is oscillating. Instead, the springs 262 may be configured to provide a reference point in space for vertical oscillation to begin. For example, the housing assembly 244 may rest against the springs 262 when the housing assembly 244 is at a resting position (e.g., not moving, etc.). As such, the springs 262 may be low-rate springs that are not at resonance during target frequencies of the oscillation. It should be appreciated that the springs 262 may be located otherwise in other example embodiments, for example, within the cylinder 102, etc. That said, in general in this example, the rods 260 and the springs 262 are used as linear guides for the moving the housing assembly 244. Other structures may be used in other examples for keeping the housing assembly 244 positioned as desired and for facilitating oscillation a desired direction (e.g., linear bearings and rails, roller bearings, DELRIN® guides, wheels and axles, etc.).

In the embodiment of FIG. 2, the housing assembly 244 is moveably coupled to the rail assemblies 246. More specifically, the top housing member 252 of the housing assembly 244 is moveably coupled to the rods 260 (via the bushings 258) to allow the housing assembly 244 to move linearly (e.g., up and down as viewed in FIG. 2, etc.) along the rods 260 and generally against the springs 262 (e.g., when moving generally downward, etc.).

With continued reference to FIG. 2, the sample block assembly 250 includes the sample block 142 of FIG. 1, a plate (or support or first support) 264, a lid 266 (or support or second support), and clamping (or holding or retaining) devices 268. The plate 264 supports the sample block 142, and is coupled between the sample block 142 and the top housing member 252 of the housing assembly 244. As shown in FIG. 2, the plate 264 may be coupled to the top housing member 252 of the housing assembly 244 via a bracket 272. The lid 266 is configured to cover the sample block 142.

Each clamping device 268 includes a clutch 269 (e.g., a built-in clutch, etc.) configured to releasably secure the lid 266 to the plate 264, as shown in FIG. 2. For example, in positioning the sample block 142 in the sample block assembly 250, the lid 266 may be forced downward in steps, whereby the clutches 269 of the clamping devices 268 may grasp legs 270 extending from the lid 266 at each step (e.g., progressively further down the legs, etc.) and prevent (or inhibit) the lid 266 from inadvertently releasing. If it is desirable to remove, loosen, etc. the lid 266, the clutches 269 may be disengaged (e.g., mechanically released from the legs 270 of the lid 266 (e.g., by pushing, selecting, etc. a release member on the clamping devices 268), etc.) to allow the lid 266 to move away from the sample block 142 and the plate 264 (e.g., to allow the legs 270 to move back through the clamping devices 268, etc.).

In some examples, the clamping devices 268 (e.g., the clutches 269, etc.) may become automatically tighter as the grinder system 200 operates. For example, when the cylinder 102 and the position 104 oscillate, the housing assembly 244 and the sample block assembly 250 coupled to the cylinder 102 move linearly downward and upward as explained herein. As part of this movement, when the sample block assembly 250 moves downward, the lid 266 may be forced slightly downward (e.g., due to the acceleration force associated therewith, etc.) such that the clutches 269 of the clamping devices 268 move slightly downward along the legs 270 and grasp the legs 270 at a lower position. The clutches 269 then resist movement of the lid upward when the sample block assembly 250 moves upward. In such examples, the lid 266 will not release or otherwise loosen until the clutches are disengaged as explained above. In other words, as the grinder system 200 operates, the clamping devices 268 may become automatically tighter (e.g., the lid 266 may progressively become more secure in holding the sample block 142 in the sample block assembly 250, etc.) while being unable to loosen (until desired or intended).

That said, the clutch 269 of each of the clamping devices 268 may be configured to engage a corresponding one of the legs 270 as desired to thereby hold the lid 266 in position relative to the sample block 142 (and, in some instances, to provide the progressively tighter retention of the sample block 142 described above). For instance, in some embodiments the clutch 269 may include a sleeve (e.g., as illustrated in FIG. 2A, etc.) configured to frictionally engage a corresponding one of the legs 270. In connection therewith, the sleeve is configured to progressively slide (or move) down the leg 270, for example, as the lid 266 is pressed down on the sample block 142 (e.g., manually by a user, automatically as the grinder system 200 operates to move the sample block 142, etc.), but resists movement in an upward direction of the leg (unless specifically disengaged from the leg 270). Additionally, or alternatively, in some embodiments the clutch may include a detent configured to fit into (or be received into) one of multiple recess defined along a length of the corresponding leg.

In the example of FIGS. 2A-2F, oscillation between the cylinder 102 and the piston 104 may be controlled (e.g., via the controller 114, etc.) in a similar manner as explained above relative to FIG. 1. For example, the controller (e.g., controller 114, etc.) is configured to adjust (e.g., increase, decrease, etc.) air pressure in the end portions 116, 118 of the cylinder 102 (e.g., at members 252, 254, etc.) by supplying air to or exhausting air from the end portions 116. 118 (and/or from the members 252, 254, etc.). As a result of the changing air pressure in the end portions 116, 118, the piston 104 is configured to move in one linear direction within the cylinder 102 while, at the same time, the cylinder 102 and the housing assembly 244/the sample block assembly 250 coupled to the cylinder 102 are configured to move in the opposite linear direction along the rods 260 of the rail assemblies 246 (e.g., via a pushing and recoil action by the air on the cylinder 102 and the piston 104 within one of the end portions 116, 118; etc.). The control of the air pressure in the end portions 116, 118 of the cylinder 102 may be based on feedback signals provided by the sensors 110, 112 as explained above. Additionally, the system 200 may be configured to create self-oscillating and self-balancing interactions between the cylinder 102 (and the housing assembly 244/the sample block assembly 250) and the piston 104 as explained above.

The oscillating movement of the cylinder 102 and the piston 104 of the system produces a sufficient acceleration force (e.g., G force, etc.) to agitate the samples and the grinding devices in the sample block 142. The rate of oscillation and the G force applied to the sample block 142 may be determined by the controllable air pressure. As a result of the agitation, the samples in the sample block 142 may be ground. For example, varying air pressure between about 30 psi and about 95 psi may achieve a G force between about 8 G and about 25 G for performing grinding operation on the samples. In some embodiments, a G force of between about 12 G and about 14 G may be required to sufficiently grind the samples (e.g., chips, etc.). If the sample block 142 includes plastic, the plastic will not likely crack in this G force range. In some examples, an air pressure of about 60 psi may be used to achieve a G force of about 13 G when the stroke is about ⅝ of an inch at about 1,200 cycles per minute.

FIG. 3 illustrate another example embodiment of a grinder system 300 including one or more aspects of the present disclosure. The grinder system 300 of FIG. 3 is similar to the system 200 of FIG. 2, and includes controller 314 configured to control air pressure, to thereby linearly move (e.g., oscillate, etc.) a cylinder and a piston in opposing directions as explained above. For example, the system 300 includes the housing assembly 244, the rail assemblies 246, the support member 248, the bracket 272 (of the sample block assembly 250), the cylinder 102, the piston, the air ports 106, 108, and the sensors 110, 112 (as generally described in connection with FIGS. 1 and 2), and the controller 314. The controller 314, then, is in communication with the air ports 106, 108 and the sensors 110, 112 as explained above (and as generally illustrated in FIG. 1).

In the illustrated embodiment of FIG. 3, the controller 314 include a valve such as a shuttle valve, a solenoid valve, etc. The valve is configured to actuate in response to the feedback signals from the sensors 110, 112, to thereby control the air pressure in the cylinder 102 as explained above. In doing so, the valve selectively connects an air source (e.g., air source 138, etc.) to one of the air ports 106, 108 and connects an exhaust (e.g., exhaust 140, etc.) to the other one of the air ports 106, 108, and then, when triggered or actuated, selectively connects the air source (e.g., air source 138, etc.) to the other one of the air ports 106, 108 and connects the exhaust (e.g., exhaust 140, etc.) to the other one of the air ports 106, 108. Alternatively, the controller 314 may include another suitable device configurable to control air pressure between the air ports 106, 108, for example, such as a processor (and memory) as explained herein.

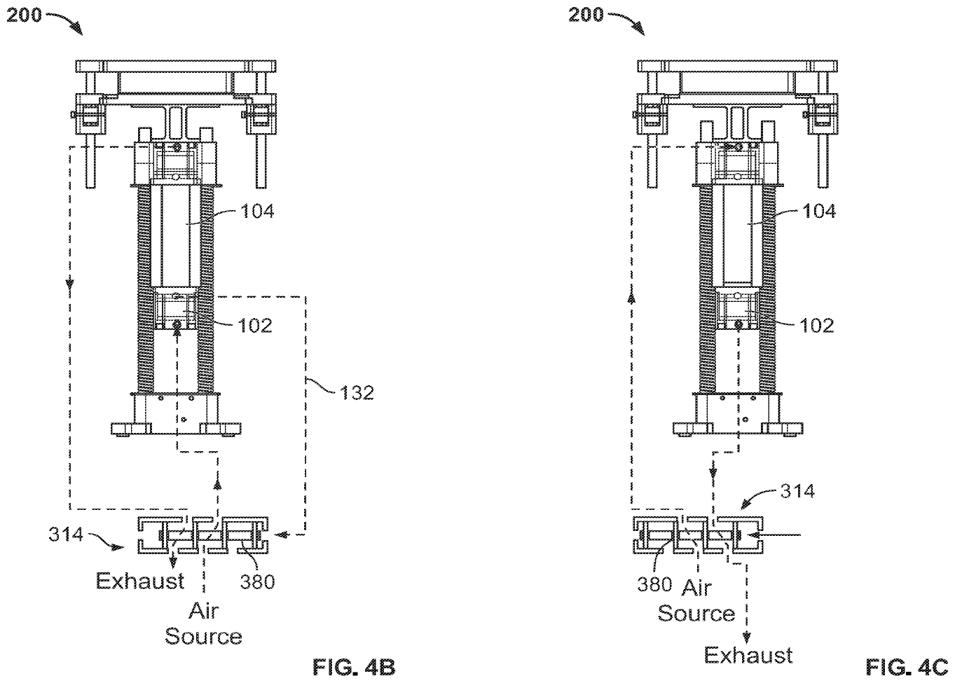

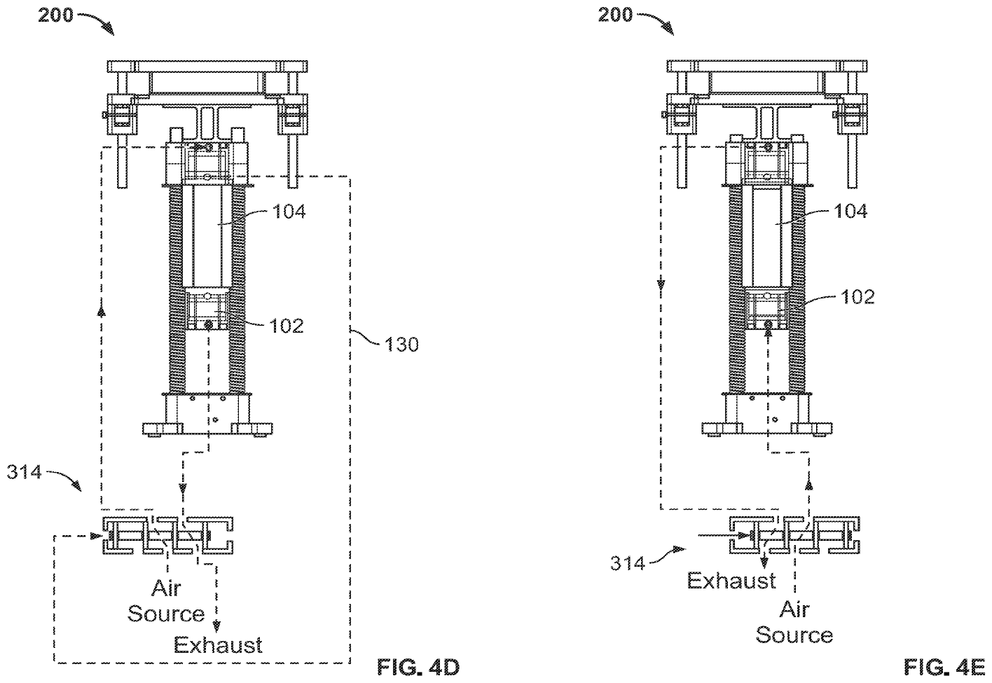

FIGS. 4A-4E illustrate an example method (or operation) for controlling air pressure in a cylinder to oscillate the cylinder, and a piston within the cylinder, as explained herein. The example method is described herein with reference to the system 200 (and the system 100), and may be implemented, in whole or in part, in the controller 314 of the system 300 (and/or controller 114 of the system 100). In the example of FIGS. 4A-4E, the controller 314 includes a valve such as a shuttle valve 380. However, it should be appreciated that the method, or other methods described herein, are not limited to the system 200 (or the system 100) or the controller 314 (with the shuttle valve 380) of the system 300. And, conversely, the systems and the controllers described herein are not limited to the example method described with respect to FIGS. 4A-4E.

Initially, in the method of FIGS. 4A-4E, the piston 104 and the cylinder 102 are generally vertical in orientation and begin in a resting position. For example, the resting position of the cylinder 102 is determined by the housing member 252 of the housing assembly 244 resting against the springs 262 (FIG. 2). The springs 262 provide a reference point in space for vertical oscillation to begin, as explained above. The resting position of the piston 104 is a low position (e.g., a defined low threshold position, etc.) within the cylinder 102.

The controller 314 then controls the shuttle valve 380 so that air (e.g., compressed air from air source 138, etc.) is supplied to the housing member 254 (e.g., the bottom housing member, etc.) of the housing assembly 244 (via the air port 108) and exhausted from the housing member 252 (e.g., the top housing member, etc.) of the housing assembly 244 (via the air port 106), as shown in FIG. 4A. For example, compressed air may be applied to a space between a bottom face of the piston 104 and a bottom of the cylinder 102, and removed from a space between a top face of the piston 104 and a top of the cylinder 102.

When air is supplied to the bottom housing member 254 and exhausted from the top housing member 252, the air pushes on both the cylinder 102 and the piston 104 such that the piston 104 begins to move linearly upward and the cylinder 102 along with the housing assembly 244 and the sample block assembly 250 begin to move linearly downward (based on the pushing and corresponding recoil effects of the air), as shown in FIGS. 4A-4B. Once the sensor 112 begins to sense an absence of the piston 104, or movement of the piston 104, etc. (e.g., due to the piston 104 rising, etc.), the sensor 112 generates and provides the feedback signal 132 to the controller 314, as shown in FIG. 4B. In response, the controller 314 begins to actuate the shuttle valve 380. The shuttle valve 380 may be, for example, actuated (e.g., moved, etc.) with pressure (e.g., air pressure, etc.), a mechanical force, etc.

When the piston 104 reaches a maximum height (e.g., a defined high threshold position, etc.) and the cylinder 102 reaches a minimum height, the shuttle valve 380 fully transitions (e.g., due to the applied pressure, mechanical force, etc.). At this time, air begins to be supplied to the top housing member 252 and exhausted from the bottom housing member 254 as shown in FIG. 4C. For example, compressed air may be applied to the space between the top face of the piston 104 and the top of the cylinder 102, and removed from the space between the bottom face of the piston 104 and the bottom of the cylinder 102.

When air is supplied to the top housing member 252 and exhausted from the bottom housing member 254, the piston 104 begins to move linearly downward and the cylinder 102 along with the housing assembly 244 and the sample block assembly 250 begin to move linearly upward, as shown in FIG. 4D (in the same manner as described above, for example, based on the pushing and corresponding recoil effects of the air). Once the sensor 110 begins to sense an absence of the piston 104, or movement of the piston 104, etc. (e.g., due to the piston 104 lowing, etc.), the sensor 112 generates and provides the feedback signal 130 to the controller 314, as shown in FIG. 4D. In response, the controller 314 begins to actuate the shuttle valve 380.

When the piston 104 reaches a minimum height (e.g., the defined low threshold position, etc.) and the cylinder 102 reaches a maximum height, the shuttle valve 380 fully transitions (e.g., due to the applied pressure, mechanical force, etc.), as shown in FIG. 4E. At this time, air begins to be supplied to the bottom housing member 254 and exhausted from the top housing member 252, as shown in FIG. 4E. When air is supplied to the bottom housing member 254 and exhausted from the top housing member 252, the piston 104 begins to move linearly upward and the cylinder 102 along with the housing assembly 244 and the sample block assembly 250 begin to move linearly downward (e.g., as shown in FIG. 4A, etc.).

This sequence shown in FIGS. 4A-4E may be repeated thereby creating a self-supporting oscillating system, with the oscillating speed determined based on the air pressure (e.g., a higher pressure results in a higher cycles per minute, etc.), etc. The oscillating movement produces a sufficient acceleration force (e.g., G force, etc.) to agitate the samples and the grinding devices in the sample block 142, thereby grinding the samples, as explained above. Once the air supply is ceased, the piston 104 and the cylinder 102 return to their resting positions, as explained above.

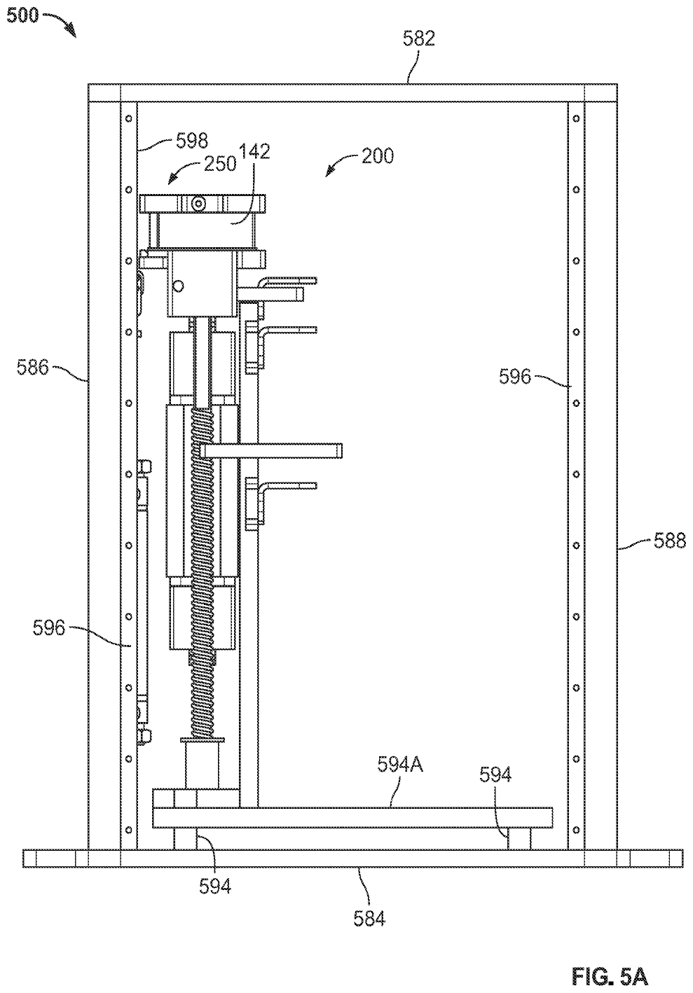

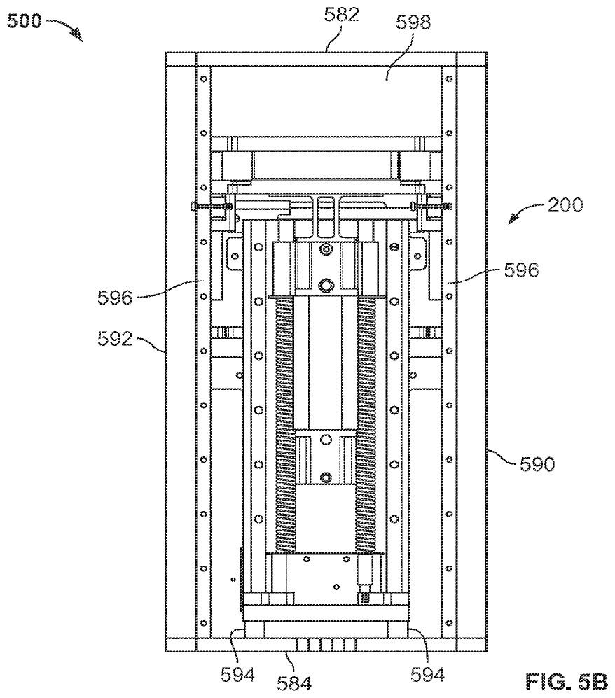

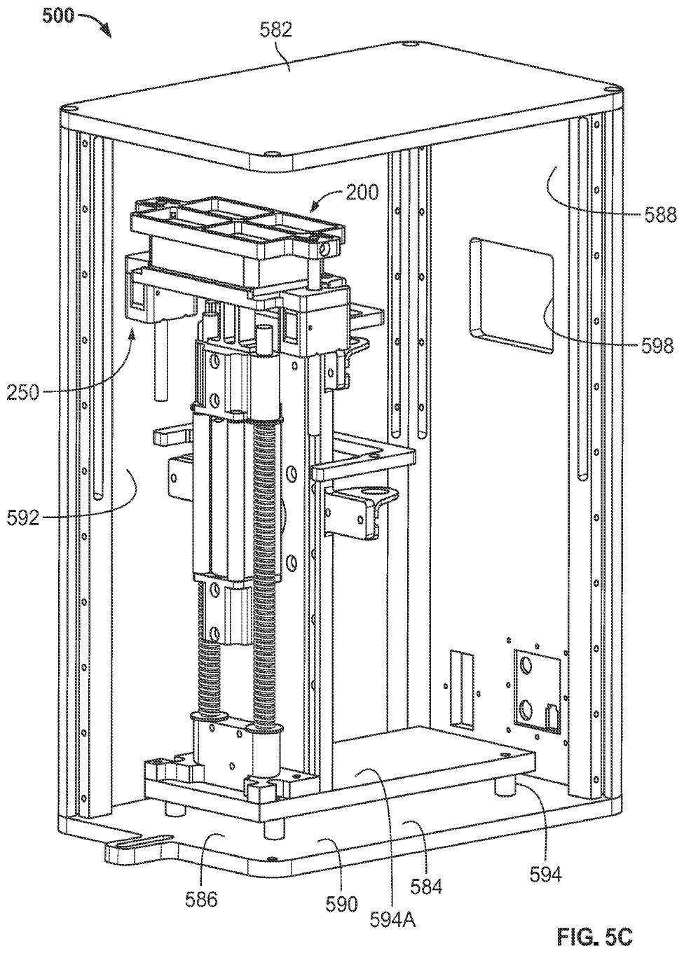

FIGS. 5A-5C illustrate a case 500 according to one or more aspects of the present disclosure for holding or housing a grinder system of the present disclosure. In the illustrated example of FIGS. 5A-5C, the case 500 (broadly, a housing) includes (as an example) the grinder system 200 of FIG. 2, a lid 582, a base 584 opposing the lid 582, four side panels 586, 588, 590, 592 extending between the lid 582 and the base 584, four isolators 594, insulation 596, and a passthrough 598 to allow for airflow in the case 500. In connection therewith, side panel 586 may provide (or operation as or function as) an access door to allow for access to an interior of the case 500. Although the case 500 is illustrated in the arrangement as shown in FIGS. 5A-5C, it should be appreciated that the case 500 may be arranged differently and/or include different components in other embodiments. For example, the case 500 may include a different grinder system such as the grinder system 100, the grinder system 300, etc.

In the example of FIGS. 5A-5C, the lid 582, the base 584, and the side panels 586, 588, 590, 592 may be any suitable material. For example, the lid 582, the base 584, and/or the side panels 586, 588, 590, 592 may be a metal material, a plastic material, etc. The metal material may include, for example, aluminum, steel (e.g., stainless steel, etc.), etc. The plastic material may include, for example, polycarbonate and/or another suitable polymer material. In some embodiments, the lid 582 and the base 584 are aluminum (e.g., ½ inch thick aluminum, etc.), and the side panels 586, 588, 590, 592 are polycarbonate (e.g., ½ inch thick polycarbonate, etc.).

As shown in FIGS. 5A-5C, the isolators 594 extend between and separate the grinder system 200 and the base 584. More specifically, the isolators 594 extend between a platform 594A supporting the grinder system 200 and the base 584. The isolators 594 may be any suitable material configured to absorb vibration created by the system 200 when operating. For example, the isolators 594 may be rubber or another suitable material.

The insulation 596 may extend along the side panels 586, 588, 590, 592. For example, the insulation 596 may extend along corners between connecting pairs of the side panels 586, 588, 590, 592. In some examples, the insulation 596 may be configured to reduce noise from exiting the case 500 when the system 200 is operating. The insulation 596 may be any suitable material such as foam, fiberglass, etc.

As shown in FIGS. 5A-5C, in this embodiment, the side panel 586 serves as an access door for the case 500, for instance, to allow access to the sample block assembly 250. For instance, in some examples, the side panel 586 may be configured to open (entirely or partially) thereby providing access to the sample block 142. In some such examples, the panel 586 may define an opening with an access door defined therein to allow a user, a robot, etc. to reach into the case 500 and access the sample block 142 when the access door (of the panel 586) is in an open position. As such, the user, the robot, etc. may place and/or remove sample blocks in the system 200. In some examples, the access door may couple to the side panel 586 via one or more hinges, etc.

As indicted above, the grinder systems disclosed herein may be used to agitate and grind any suitable organic or inorganic material. For example, the grinder systems may be used with biological materials including plants, animals, and/or materials derived therefrom. Plants and materials derived therefrom may include, for example, whole seeds, tissue samples from seeds, leaves, leaf tissues, roots, root tissues, stems, stem tissues, flowers, flower tissues, fruit, fruit tissues, etc. Animals and materials derived therefrom may include, for example, insects, insect tissues, nematodes, nematode tissues, arachnids, arachnid tissues, etc. Further, in some embodiments, the grinder systems may be used with dirt, rocks and/or materials used in the pharmaceutical industry.

The sample blocks disclosed herein may include one or more wells for receiving samples and grinding devices. Such samples may include various products including, for example, seeds, chips or samples from seeds, dried plant tissue, animal tissue, coffee beans, spices, animals, animal parts, soil, rocks, etc. The grinding devices may include, for example, BBs, ball bearings, and/or any other suitable object capable of grinding (e.g., chipping, etc.) the samples. In some examples, the sample blocks include 96 wells (e.g., well plates, etc.). In such examples, each well may receive one or more samples and one or more grinding devices. In other examples, the sample blocks may include more or fewer wells, such as 1 well, 4 wells, 6 wells, 8 wells, 10 wells, 12 wells, 24 wells, 25 wells, 36 wells, 48 wells, 56 wells, 78 wells, 96 wells, 110 wells, 150 wells, 384 wells, 1536 wells, and/or another suitable amount.

In addition, the sample blocks herein may include any suitable shape. For example, the sample blocks may have a block shape (e.g., a generally cubic shape, a generally box shape, a generally square or generally rectangular shape, etc.) having rectangular and/or square sides, etc. In other embodiments, the sample blocks may have other shapes such as cylinder shapes, tubular shapes, or other suitable shapes.

Further, the sample blocks may be any suitable material and any suitable size. For example, the sample blocks may be formed of plastic and/or another suitable material. For instance, the sample blocks may be formed of a plastic material such as, for example, polypropylene. In other examples, the sample blocks may be formed of stainless steel, Teflon, or other suitable non-reactive plastics or metals. In some embodiments, the sample blocks may have dimensions that may be about 85 mm×125 mm, and about 25 mm tall, and constructed from material that may be about 1.1 mils thick. In other embodiments, the sample blocks may be smaller or larger.

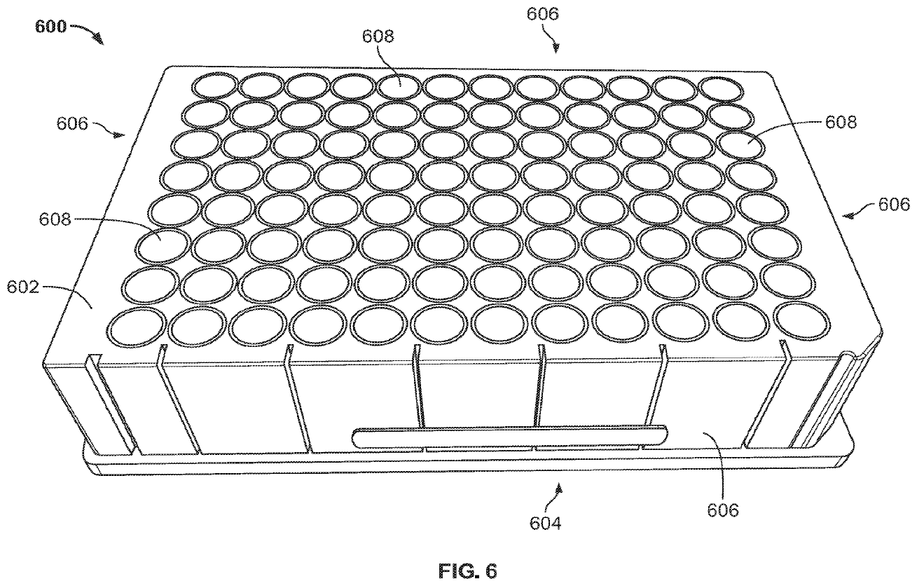

That said, FIG. 6 illustrates an example embodiment of a sample block 600 that may be employed in any one of the grinding systems herein. As shown, in this example the sample block 600 is generally rectangular in shape, with a top portion 602, a bottom portion 604, and four side portions 606 extending between the top portion 602 and the bottom portion 604. In addition in this example, the sample block 600 is plastic and includes 96 wells 608 extending from the top portion 602 for receiving samples and grinding devices. As shown, in this example, the wells 608 are formed in an 8 well by 12 well rectangular array. Although the sample block 600 of FIG. 6 is shown and described as including a particular number of wells, shape, and material, it should again be appreciated, as described above, that the sample block 600 and/or any other sample block herein may be configured differently in other embodiments (e.g., may include a different number of wells, a different arrangement of wells, be constructed of a different material, include a different shape, etc.).

The pistons and the cylinders disclosed herein may suitable material. For example, the pistons and/or the cylinders may be steel, carbon fiber, and/or another suitable metallic material. In some systems disclosed herein, the pistons may be steel and the cylinders may be carbon fiber.

The pistons disclosed herein may have any suitable size. For example, the size of the piston may be based on parameters of the corresponding system, the material of the piston, etc. For instance, if the net weight of the housing assembly and the cylinder moving in the opposite direction of the piston is roughly 1 kg, then it may be desirable for the weight of the piston to be roughly 1 kg. In such examples, the piston may be about 6 inches long and have about a 1.5 inch diameter to ensure the piston is about 1 kg. In other nonlimiting examples, the pistons may be about 5 inches, about 7 inches, more or less than about 5 inches, more or less than about 6 inches, or more or less than about 7 inches, and/or any other suitable distance, and have a diameter of about ½ inch, about 1 inch, about 2 inches and/or any other suitable diameter depending on, for example, the size of the cylinder.

Additionally, the cylinders disclosed herein may have any suitable size. For example, the cylinders may have any suitable length greater than the length of their corresponding pistons. Nonlimiting examples include about 6 inches, about 7 inches, about 8 inches, more or less than about 6 inches, more or less than about 7 inches, or more or less than about 8 inches, etc.

The stroke for the oscillating cylinders and pistons disclosed herein may be controlled by, among other things, sensor position. The use of sensors may ensure the pistons do not fully travel to opposing ends of the cylinders. For example, the sensors disclosed herein may be placed along, within, etc. the cylinders at any suitable distance from the ends of the cylinders. In some examples, the sensors may be placed about an inch from the ends of the cylinders. In other examples, the sensors may be placed more of less than about an inch from the ends of the cylinders. In one embodiment, the sensors may be positioned about 1.17 to about 1.2 inches from the ends of the cylinders to ensure the control valve (if employed) has enough time to change flow direction before contacting one of the ends of the cylinder.

Testing has shown that the systems disclosed herein are configurable to achieve a desired G force to sufficiently grind (e.g., chip, etc.) samples. For example, any one of the systems is configured to oscillate a cylinder and a piston through the control of air pressure. With this oscillation, a G force of between about 10 G and about 16 G (or between about 12 G and about 14 G, etc.) may be achieved. The G force varies based on the air pressure. For example, the systems may generate an acceleration force of about 8 G at about 30 psi, about 24 G at 90 psi, and between about 12-14 G at about 60 psi, etc.

For example, Table 1 below shows various parameters of an oscillating cylinder and piston, and Table 2 below shows formulas/definitions for calculating parameters in Table 1. In the example below, the frequency may be variable based on the air pressure (e.g., the frequency may change linearly with a changing air pressure, etc.), and the displacement may be variable based on the mass of the cylinder/housing and the mass of the piston.

TABLE 1
Results

| Parameter | Value | |
|---|---|---|
| Frequency | 20 | [Hz] |
| Displacement (peak-to-peak) | 15.975 | [mm] |
| Velocity (peak) | 1003.73889 | [mm/s] |
| Acceleration (peak) | 12.86204 | [g] |

TABLE 2

| | |
|---|---|
| Displacement Formula | x = Dsin(2πft)/2 |
| Velocity Formula | v = πfDcos(2πft) |
| Acceleration Formula | a = −2π²f²Dsin(2πft) |
| Displacement peak-to-peak value | D |
| Time (seconds) | t |
| Frequency (Hertz) | f |

Testing has also shown that the systems disclosed herein are reliable. For example, the systems may operate for over 2,000 cycles (at 30 second cycles), operate continuously for extend periods of time (e.g., more than 120 hours, etc.) at 20 Hz (e.g., 1,200 cycles per minute, etc.), etc. without system breakdown, component failure, etc. Further, the systems impart nearly zero vibration to its surroundings, even when the systems generate force levels of 25 G or more. What's more, a low amount of air consumption is required to achieve high force levels. For example, the systems may under 3 CFM of air to achieve between about 12-14 G.

In view of the above, the grinder systems and methods herein may leverage controlled air pressure to oscillate (e.g., shuttle, etc.) pistons and cylinders/housings in opposing linear directions. As a result of the oscillation, samples in a sample block coupled to the cylinders/housings may be disrupted and ground. As such, the systems and methods herein create controllable linear cyclical motion, through two moving parts, to disrupt and grind samples. Because the disruption is generated from linear cyclical motion controlled by air pressure, motors may not be required to directly disrupt and grind the samples. Additionally, seals are not required between components (e.g., the piston and the cylinder, etc.) moving relative to one another. As such, the grinder systems herein may experience a longer lifespan and require less replacement/repair of components as compared to conventional grinders.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A grinder system for grinding at least one sample in a sample block, the grinder system comprising:
a cylinder including a first end portion and a second end portion opposing the first end portion, the cylinder defining a bore extending along a longitudinal axis of the cylinder, the first end portion of the cylinder configured to couple to a sample block configured to hold at least one sample and at least one grinding device, the cylinder configured to linearly move in at least a first direction;
a first air port adjacent to the first end portion of the cylinder;
a second air port adjacent to the second end portion of the cylinder;
a piston positioned in the bore of the cylinder and configured to move along the longitudinal axis of the cylinder; and
a controller configured to control air pressure in the first end portion and the second end portion of the cylinder via the first air port and the second air port, to thereby linearly move the cylinder in at least the first direction and the piston in at least a second direction opposite the first direction to agitate at least one grinding device in the sample block to grind the at least one sample in the sample block.

2. The grinder system of claim 1, further comprising a housing assembly including a first member coupled to the first end portion of the cylinder and a second member coupled to the second end portion of the cylinder, the first member configured to couple the first end portion of the cylinder and the sample block.

3. The grinder system of claim 2, further comprising at least one sensor configured to generate a feedback signal indicative of a position of the piston in the bore of the cylinder, wherein the controller is configured to receive the feedback signal from the at least one sensor, and in response to the feedback signal, control the air pressure in the first end portion and the second end portion of the cylinder via the first air port and the second air port, to thereby linearly move the cylinder in at least the first direction and the piston in at least the second direction opposite the first direction.

4. The grinder system of claim 3, wherein each of the first member and the second member includes a top side and an opposing bottom side, wherein the at least one sensor includes a first sensor and a second sensor, and wherein the first air port is positioned between the top side of the first member and the first sensor, and the second air port is positioned between the second sensor and the bottom side of the second member; or
wherein the controller includes a valve and wherein, in response to the feedback signal, the valve is configured to actuate, to thereby control the air pressure in the first end portion and the second end portion of the cylinder.

5.-6. (canceled)

7. The grinder system of claim 1, wherein the cylinder includes an inner surface defining the bore, and wherein the piston is configured to create an airtight seal with the inner surface of the cylinder.

8. The grinder system of claim 1, further comprising one or more rail assemblies each including a rod extending generally parallel to the cylinder and a spring positioned about the rod, wherein the cylinder is configured to linearly move along each rod in the first direction and in the second direction opposite the first direction.

9. (canceled)

10. The grinder system of claim 1, further comprising the sample block coupled to the cylinder.

11. The grinder system of claim 10, further comprising a plate coupled between the sample block and the cylinder, a lid configured to cover the sample block, and a clamping device configured to releasably secure the lid to the plate; and
wherein the clamping device is configured to automatically tighten the lid to the plate when the cylinder and the piston move.

12. (canceled)

13. The grinder system of claim 1, wherein the controller is configured to control air pressure in the first end portion and the second end portion of the cylinder via the first air port and the second air port, to thereby linearly move the cylinder in the second direction and the piston in the first direction within the bore of the cylinder.

14. A method of grinding at least one sample in a sample block coupled to a cylinder, the method comprising:
controlling air pressure in the cylinder to linearly move a piston in a bore of the cylinder in a first direction and linearly move the cylinder in a second direction opposite the first direction, thereby agitating at least one grinding device in the sample block to grind the at least one sample.

15. The method of claim 14, further comprising controlling air pressure in the cylinder to linearly move the piston in the bore of the cylinder in the second direction and linearly move the cylinder in the first direction.

16. The method of claim 14, further comprising;
receiving a feedback signal from at least one sensor, the feedback signal indicative of a position of the piston in the bore of the cylinder, and wherein controlling the air pressure includes controlling the air pressure in the cylinder in response to the received feedback signal; and
in response to the received feedback signal, controlling air pressure in the cylinder to linearly move the piston in the bore of the cylinder in the second direction and linearly move the cylinder in the first direction.

17.-18. (canceled)

19. A grinder system for grinding at least one sample in a sample block, the grinder system comprising:
a housing assembly including a first member and a second member, the first member configured to couple to a sample block and including a first air port and a first sensor, and the second member including a second air port and a second sensor;
a cylinder coupled between the first member and the second member of the housing assembly, the cylinder defining a bore extending along a longitudinal axis of the cylinder;
at least one rail assembly including a rod extending parallel to the cylinder and a spring positioned about the rod, the housing assembly and the cylinder configured to linearly move along the rod in a first direction and in a second direction opposite the first direction;
a piston positioned in the bore of the cylinder and configured to move along the longitudinal axis of the cylinder; and
a controller in communication with the first sensor and the second sensor, the controller configured to receive a feedback signal from the first sensor or the second sensor indicative of a position of the piston in the bore of the cylinder, and in response to the feedback signal, control air pressure in the cylinder via the first air port and the second air port, to thereby linearly move the piston in a direction opposite a direction of movement of the housing assembly and the cylinder, and agitate at least one grinding device in the sample block to grind at least one sample.

20. The grinder system of claim 19, wherein the controller is configured to, in response to the feedback signal, increase the air pressure in one portion of the cylinder and decrease the air pressure in another portion of the cylinder, to thereby linearly move the piston in the direction opposite the direction of movement of the housing assembly and the cylinder.

21. The grinder system of claim 20, wherein the controller is configured to, in response to the feedback signal, decrease the air pressure in said one portion of the cylinder and increase the air pressure in said another portion of the cylinder, to thereby linearly move the piston in the direction opposite the direction of movement of the housing assembly and the cylinder.

22. The grinder system of claim 19, further comprising the sample block coupled to the first member of the housing assembly and a support member coupled to the at least one rail assembly, the rod of the at least one rail assembly including a first end adjacent to the first member of the housing assembly and an opposing second end coupled to the support member.

23. The grinder system of claim 22, further comprising a plate coupled between the sample block and the first member of the housing assembly, a lid configured to cover the sample block, and a clamping device including a clutch configured to releasably secure the lid to the plate; and
wherein the clutch of the clamping device is configured to automatically tighten the lid to the plate when the cylinder and the piston move.

24. (canceled)

25. A grinder system for grinding at least one sample in a sample block, the grinder system comprising:
a first support configured to hold a sample block and move the sample block, the sample block configured to hold at least one sample and at least one grinding device for grinding the at least one sample as the first support moves the sample block;
a second support configured to cover the sample block; and
a clamping device configured to releasably secure the second support to the first support to thereby secure the sample block between the first support and the second support, wherein the clamping device includes a clutch configured to automatically tighten the second support to the first support as the first support moves the sample block.

26. The grinder system of claim 25, further comprising a leg coupled to the first support; and
wherein the clutch includes a sleeve configured to position about the leg, the clutch configured to move along the leg toward the first support to thereby tighten the second support to the first support as the first support moves the sample block.

27. The grinder system of claim 26, wherein the sleeve is configured to frictionally engage the leg and resist movement of the sleeve generally away from the first support as the first support moves the sample block.

28. The grinder system of claim 25, further comprising:
a cylinder including a first end portion and a second end portion opposing the first end portion, the cylinder defining a bore extending along a longitudinal axis of the cylinder, the first end portion of the cylinder configured to couple to the first support, the cylinder configured to linearly move in at least a first direction;
a first air port adjacent to the first end portion of the cylinder;
a second air port adjacent to the second end portion of the cylinder;
a piston positioned in the bore of the cylinder and configured to move along the longitudinal axis of the cylinder; and
a controller configured to control air pressure in the first end portion and the second end portion of the cylinder via the first air port and the second air port, to thereby linearly move the cylinder in at least the first direction and the piston in at least a second direction opposite the first direction to agitate the at least one grinding device in the sample block to grind the at least one sample in the sample block.

29. The grinder system of claim 25, further comprising the sample block.
